(19) United States
(12) Patent Application Publication
(10) Pub. No.: US 2017/0138873 A1
(43) Pub. Date: May 18, 2017

(54) MEASURING CELL OF DIFFERENTIAL SCANNING CALORIMETER

(71) Applicant: SCHLUMBERGER TECHNOLOGY CORPORATION, Sugar Land, TX (US)

(72) Inventors: Evgeny Nikolaevich Dyshlyuk, Dhahran (SA); Vitaly Alekseevich Baldygin, Moscow (RU)

(21) Appl. No.: 15/353,958

(22) Filed: Nov. 17, 2016

(30) Foreign Application Priority Data
Nov. 17, 2015 (RU) 2015149116

(51) Int. Cl. G01N 25/48

(52) U.S. Cl. CPC G01N 25/4866; G01N 25/4833

(57) ABSTRACT

A measuring cell of a differential scanning calorimeter comprises a cylindrical housing made of a high thermal conductivity metal. At least one metal disk-shaped insert made of a high thermal conductivity metal is disposed in the housing, an upper part of the disk-shaped insert has a recess for placing a sample of a test material. There is a sealed lead-in in an upper part of the housing for evacuating the cell and for supplying a liquid into the cell, and a lower part of the housing is equipped with a sealed cover capable of being sealed in the housing.

### CROSS-REFERENCE TO RELATED APPLICATION

This application claims priority to Russian Application No. 2015149116 filed 17 Nov., 2015, which is incorporated herein by reference in its entirety.

### BACKGROUND

The disclosure relates to thermoporometry, in particular, to devices for measuring pore size distribution in porous media, and can be used in various industries such as oil and gas, chemical and food industry.

The thermoporometry (cryoporometry) method relies upon calorimetric measurements of a solid-liquid (e.g. water-ice) phase transition in a porous material, and a freezing temperature of the liquid in pores depends on a pore size. With reduction in the pore size the freezing temperature of the liquid decreases, consequently, pores of a particular size feature own freezing point.

In experiments by the thermoporometry method a porous medium filled with a liquid (e.g. water) is placed into a measuring cell of a differential scanning calorimeter (DSC). DSCs are able to operate at various temperatures (range depends on the calorimeter model). To change temperature of the calorimeter chamber the chamber is heated or cooled. Controlled variation of the calorimeter chamber temperature is referred to as a temperature scanning, hence the name of scanning calorimeter. Scan mode allows, in particular, study of phase transitions accompanied by absorption or release of heat, such as a change in the phase state of a liquid.

The calorimeter chamber is cooled so that all the liquid has been frozen (for example, down to −30° C. in experiments with water), and then the calorimeter chamber is smoothly heated. In course of the experiment, the heat flux is measured against the calorimeter chamber temperature. Variation in the heat flux indicates the phase transition of an amount of the substance (the stronger the variation, the greater is the substance amount) at this temperature.

A typical DSC comprises two cells, into one of which (S) a test sample is placed. The other cell (R) is the reference cell and may either stay empty or be also filled, depending on the experiment. The cells are heat insulated from each other, have a controlled temperature, which can be varied by a heater of the calorimeter chamber. Difference of temperatures between each cell and the calorimeter chamber is typically measured by thermocouples. Proper calibration of the calorimeter allows calculation of the difference in heat fluxes between the calorimeter cells and the calorimeter chamber. Summation of the heat flux difference in time allows determining the difference in the amount of heat released or absorbed in each cell. The experimental cells in DSC are replaceable, and depending on the experiment type different pairs of experimental cells can be applied.

Due to the finite thermal conductivity of the chamber material and the measuring cell, there is always some lag between the measured temperature of the calorimeter chamber and the actual temperature of the measuring cell at the moment. In addition, the signal is “blurred”, that is, for example, instead of a narrow peak (increase in the heat flux) at zero degrees in the measurement of phase transition of water a curve of a finite thickness is obtained, which is characterized by the thermal constant of the calorimeter. To reduce the blurring of the heat flux curve, the calorimeter chamber and the measuring cell are made of a material with a high thermal conductivity (e.g. silver). The final thermal conductivity of the sample in the cell also affects the broadening of the measured curve.

A standard cylindrical cell of a calorimeter, used for experiments on thermoporometry, comprises a cylindrical vessel sealed with a lid (see, for example, “Principles of Thermal Analysis and calorimetry”, edited by P. J. Haines, 2002, p. 72). At low thermal conductivity of the sample during the experiment the sample is heated unevenly, which impairs the accuracy of the thermoporometry experiments. The thermal conductivity in the cell is determined by the thermal conductivity of the sample in the cell and therefore may be low. The cell does not provide for evacuation prior to filling with a sample and, thus, researchers cannot be confident that all void space of the cell is filled.

### SUMMARY

The disclosure provides a high thermal conductivity of a sample in a cell of a calorimeter, reduces a temperature lag effect, and enables operation with both solid porous bodies having a cylindrical shape, and powders. Furthermore, the disclosed measuring cell allows evacuating the samples and filling them with liquid media, such that an entire void volume of the cell is filled with a liquid and is free of air bubbles that reduce the thermal conductivity. The proposed design of the measuring cell is versatile and can be used in a variety of DSCs. A measuring cell of a differential scanning calorimeter comprises a cylindrical housing made of a high thermal conductivity metal. At least one metal disk-shaped insert made of a high thermal conductivity metal is disposed in the housing, an upper part of the disk-shaped insert has a recess for placing a sample of a test material. There is a sealed lead-in in an upper part of the housing for evacuating the cell and for supplying a liquid into the cell, and a lower part of the housing is equipped with a sealed cover capable of being sealed in the housing.

### BRIEF DESCRIPTION OF DRAWINGS

The invention is illustrated by drawings, where

FIG.1 shows a structure of a measuring cell in accordance with the disclosure, and

FIG. 2 shows an embodiment of a disk used in the cell.

### DETAILED DESCRIPTION

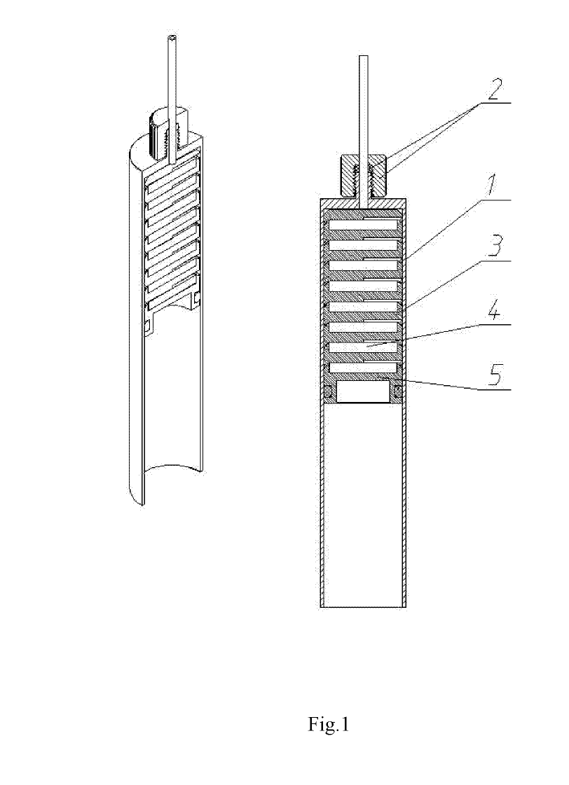

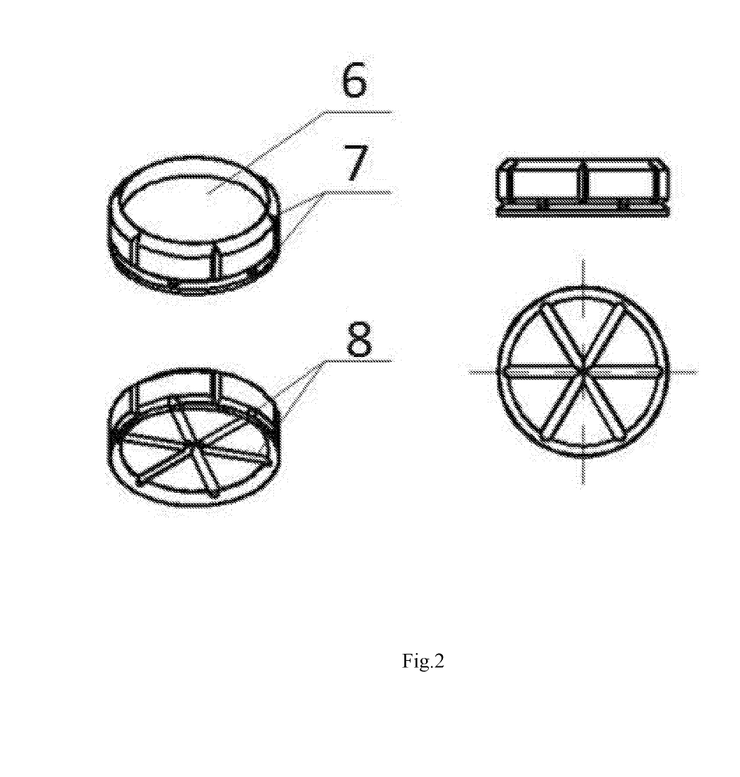

As shown in FIG. 1, major structural components of a disclosed DSC cell are a housing 1, a sealed lead-in 2, metal inserts in the shape of disks 3 with test samples 4, and a sealed cover 5. The discs 3 are secured in the housing 1 by the cover 5, which has an o-ring and which slides with resistance inside the housing 1. The number of discs 3 may be different. The sealed lead-in 2 is disposed in an upper part of the housing 1 and is intended for connecting a vacuum pump (not shown in FIG.1) and subsequently filling the cell with a liquid. The sealed lead-in is a threaded vacuum joint with metal to metal vacuum seal or another vacuum seal, for example, metal to Teflon seal. FIG.2 shows the appearance of the disk 3. An upper part of each disk 3 has a recess 6 for placing a test sample. A bottom of the disc has at least one hole 8 for evacuating and filling the test sample 4 with a liquid; an external side surface of the disk 3 can further have longitudinal and annular grooves 7.

The disclosed cell for a differential scanning calorimeter (FIG. 1) comprises a cylindrical housing of a high thermal conductivity metal (e.g. silver, copper or steel), which accommodates metal inserts—disks 3 having a specific shape and made of a high thermal conductivity metal (e.g. silver, copper, or steel). The presence of such disks can significantly increase the thermal conductivity of the sample in the cell and thereby enhance the accuracy of thermoporometry measurements. The shape of discs allows using, as a sample, both powders and solid bodies having a cylindrical shape (disk shape).

The cell operates in the following manner. Test samples are placed in the disks 3 (FIG. 1). The disks with the test samples are installed in the housing 1 and fixed, for example, the housing 1 is closed from the bottom by the sealed cover 5 having a vacuum o-ring seal. Evacuation and filling of the cell with a liquid are performed through the sealed lead-in 2. The cell is ready for operation.

A feature of the present cell is the ability to saturate the porous material with a liquid directly in the cell after the cell has been filled with a dry material. To do this, after assembling the cell with samples a vacuum line is attached to the sealed lead-in 2, the cell with the sample is evacuated, and then a liquid is fed through the same sealed lead-in to fill pores in the sample and voids in the measuring cell. This makes it possible to determine accurately the volume of liquid filling pores in the sample.

The lead-in 2 is closed and the cell with the samples is installed in a DSC. Next, a thermoporometry experiment is conducted. DSC chamber is cooled, so that all liquid in the cell froze, and then is slowly heated while making measurements of heat flux. Measurements can also be taken as the sample is being cooled. Measurement data is interpreted to obtain information on the pore size distribution in the sample.

The samples can be powders, for example, powders of controlled pore glass (CPG) can be used for accurate pre-calibration of the calorimeter. Since the pore size of these powders is well known, the measured distribution curve of the heat flux can be correlated with the pore size and further used to interpret measurements of porous media with a more complex pore size distribution.

The samples can also be solid bodies having a cylindrical shape (disks), for example, rock samples. For example, in the case of using differential scanning calorimeter BT2.15 Setaram the external size of the cell is about 15 mm in diameter. The size of one sample cylinder/disc may be about 10 mm in diameter and, for example, 2 mm in height, so about 20 discs can be used to completely fill the cell.

1. A measuring cell of a differential scanning calorimeter, comprising:
a cylindrical housing made of a high thermal conductivity metal;
at least one metal disk-shaped insert made of a high thermal conductivity metal disposed in the housing, an upper part of the disk-shaped insert having a recess for placing a sample of a test material;
a sealed lead-in in an upper part of the housing for evacuating the cell and for supplying a liquid into the cell, and
a sealed cover adapted to fix the disk-shaped inserts in the housing and to be sealed inside the lower part of the housing has.

2. The measuring cell of claim 1, wherein a side surface of the disk-shaped insert has longitudinal and circumferential grooves.

3. The measuring cell of claim 1, wherein a bottom of the disk-shaped insert has at least one hole.

4. The measuring cell of claim 1, wherein the housing is made of copper.

5. The measuring cell of claim 1, wherein the housing is made of steel.

6. The measuring cell of claim 1, wherein the housing is made of silver.

7. The measuring cell of claim 1, wherein the disk-shaped insert is made of copper.

8. The measuring cell of claim 1, wherein the disk-shaped insert is made of steel.

9. The measuring cell of claim 1, wherein the disk-shaped insert is made of silver.
